(19) United States
(12) Patent Application Publication
(10) Pub. No.: US 2006/0015356 A1
(43) Pub. Date: Jan. 19, 2006

(54) Developing a supplier-management process at a supplier

(75) Inventors: Karl Robert Erickson, Rochester, MN (US); Phillip Jay Lukowicz, Saint Charles, MN (US); David Keith Pearson, Oronoco, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/892,458

(22) Filed: Jul. 15, 2004

(51) Int. Cl. G06Q 99/00

(52) U.S. Cl. 705/1; 705/8

(57) ABSTRACT

A method, apparatus, system, and signal-bearing medium that, in an embodiment, repeatedly send different criteria to a customer's supplier, where the different criteria move the supplier from a baseline supplier-management process toward an ideal supplier-management process. A customer sends a baseline template to a supplier, receives a report from the supplier, calculates a score based on a difference between the report and an ideal supplier-management process, selects criteria from the ideal supplier-management process based on the score, and sends the criteria to the supplier. Using the criteria in a supplier-management process moves the supplier from a baseline supplier-management process towards the ideal supplier-management process. In various embodiments, a supplier-management process is any type of development, manufacture, design, test, assembly, and/or creation process for any type of materials, components, goods, and/or services.

### FIELD

An embodiment of the invention generally relates to a benchmarking of suppliers. In particular, an embodiment of the invention generally relates to the developing of a supplier-management process at a supplier.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs.

Manufacturers of computer systems typically do not fabricate every component of the computer system themselves. Instead, they may buy select components from suppliers and then assemble them. For example, a computer manufacturer may design electronic card assemblies, may buy them off-the-shelf from a supplier, or may design the electronic card assemblies, give a design specification to the supplier, and buy the custom-made electronic card assemblies from the supplier. The supplier also does not typically fabricate every component of the electronic card assembly. For example, the supplier may purchase resistors, logic, capacitors, memory, or other components from sub-suppliers. In this way, the quality of the electronic card assembly is impacted, not only by the design and assembly processes of the computer system manufacturer, but also by the supplier-management processes of the supplier, the sub-suppliers, and so on, indefinitely. As used herein, a supplier-management process is any type of development, manufacture, design, test, assembly, and/or creation process for any type of materials, components, goods, and/or services.

Although the computer manufacturer may have substantial opportunity to collect information regarding its own work and to control the quality of its own work, collecting information and controlling the quality of the work of its suppliers and sub-suppliers is far more difficult and becomes more difficult the further removed the computer manufacturer is from the sub-supplier. Further, a computer manufacturer often has many suppliers, each of which has many sub-suppliers, which further complicates efforts to maintain and improve quality and to compare and contrast the various suppliers.

Collecting information about suppliers and sub-suppliers and making decisions based on that information is often called benchmarking. Currently, benchmarking is done in a non-systematic manner and is open to subjectivity.

Without a better way to perform benchmarking, managing suppliers and sub-suppliers will continue to be difficult. Although the aforementioned problems have been described in terms of computer manufacturers and their suppliers and sub-suppliers, they may occur in any environment where a customer buys goods or services from a supplier, who may in turn buy goods or services from a sub-supplier.

### SUMMARY

A method, apparatus, system, and signal-bearing medium are provided that, in an embodiment, send different criteria to a customer's supplier, where the different criteria move the supplier from a baseline supplier-management process toward an ideal supplier-management process. A customer sends a baseline template to a supplier, receives a report from the supplier, calculates a score based on a difference between the report and an ideal supplier-management process, selects criteria from the ideal supplier-management process based on the score, and sends the criteria to the supplier. Using the criteria in a supplier-management process moves the supplier from a baseline supplier-management process towards the ideal supplier-management process.

### BRIEF DESCRIPTION OF THE DRAWING

FIG. 1 depicts a block diagram of an example system for implementing an embodiment of the invention.

FIG. 2 depicts a block diagram of an example configuration of a customer, suppliers, and sub-suppliers, according to an embodiment of the invention.

FIG. 3A depicts a block diagram of an example data structure for a supplier report, according to an embodiment of the invention.

FIG. 3B depicts a block diagram of an example data structure for a baseline template, according to an embodiment of the invention.

FIG. 3C depicts a block diagram of an example data structure for an ideal template, according to an embodiment of the invention.

FIG. 4A depicts a flowchart of example logic for a supplier, according to an embodiment of the invention.

FIG. 4B depicts a flowchart of example logic for processing parts at a supplier, according to an embodiment of the invention.

FIG. 5 depicts a flowchart of example processing for sending a baseline template to a supplier, according to an embodiment of the invention.

FIG. 6 depicts a flowchart of example processing for processing a report received from the supplier, according to an embodiment of the invention.

### DETAILED DESCRIPTION

In an embodiment, a customer sends a baseline template to a supplier. The baseline template specifies criteria for a baseline supplier-management process that the supplier is to implement to manage its own processes and to manage its sub-suppliers. The supplier periodically sends reports to the customer, which specify the actions that the supplier takes in implementing the baseline supplier-management process. The customer calculates a score based on the difference between the report and an ideal supplier-management process. Based on the score, the customer selects additional criteria from the ideal supplier-management process and sends the additional criteria to the supplier. In this way, the customer moves the supplier, over time, from the baseline supplier-management process toward the ideal supplier-management process.

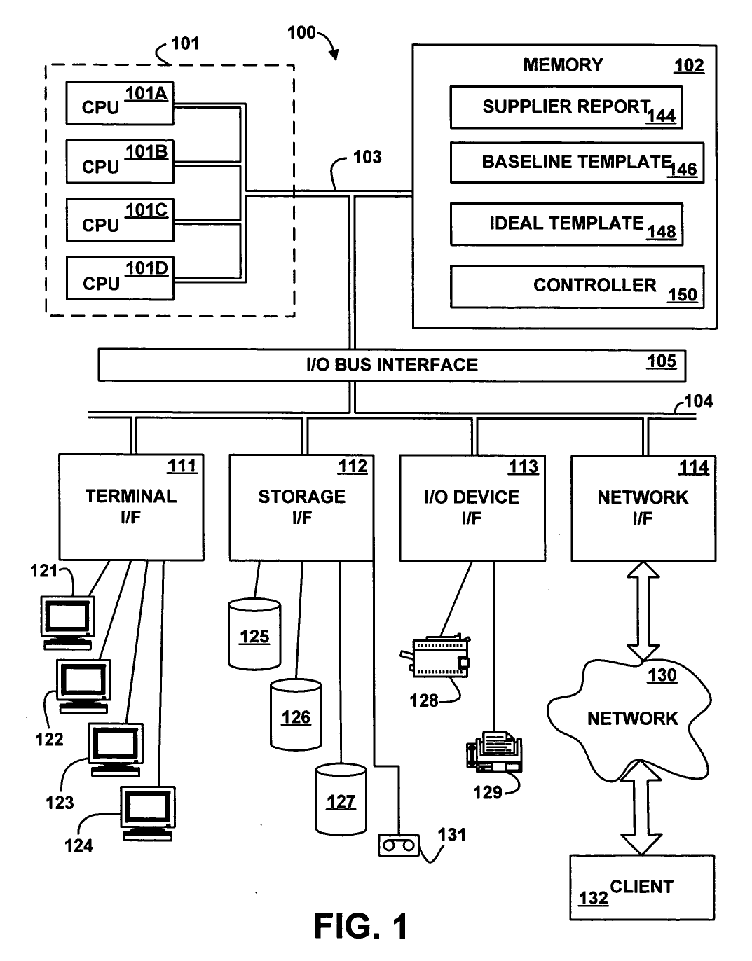

Referring to the Drawing, wherein like numbers denote like parts throughout the several views, FIG. 1 depicts a high-level block diagram representation of a computer system 100 connected to clients 132 via a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment, the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a supplier report 144, a baseline template 146, an ideal template 148, and a controller 150. Although the supplier report 144, the baseline template 146, the ideal template 148, and the controller 150 are illustrated as being contained within the memory 102 in the computer system 100, in other embodiments, some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the supplier report 144, the baseline template 146, the ideal template 148, and the controller 150 are all illustrated as being contained within the memory 102 in the computer system 100, these elements are not necessarily all completely contained in the same storage device at the same time.

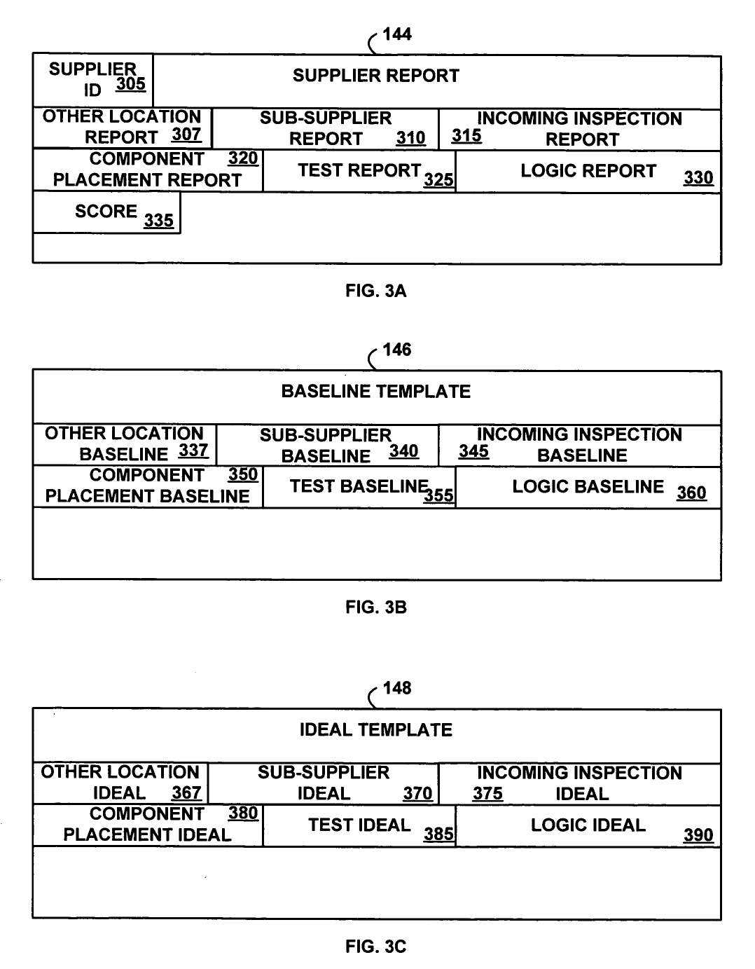

The supplier report 144 includes information reported via the client 132 from a supplier of a customer at the computer system 100. The supplier report 144 is further described below with reference to FIG. 3A. The baseline template 146 specifies a baseline supplier-management process and includes criteria, such as data and/or instructions, that the controller 150 sends to the client 132. The supplier at the client 132 uses the baseline template 146 as starting or minimum criteria for managing a supplier-management process for the supplier and optionally the supplier's sub-suppliers. As used herein, a supplier-management process is any type of manufacture, design, test, assembly, and/or creation process for any type of materials, components, goods, and/or services to be supplied by the supplier to the customer associated with the computer system 100. The baseline template 146 is further described below with reference to FIG. 3B.

The ideal template 148 specifies an ideal, optimal, or goal supplier-management process, which the customer wishes the supplier and optionally the supplier's sub-suppliers to work toward achieving. The ideal template 148 includes additional or different criteria from the baseline template 146. The ideal template 148 is further described below with reference to FIG. 3C.

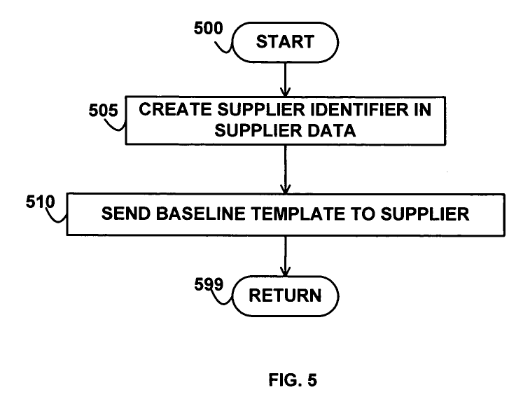

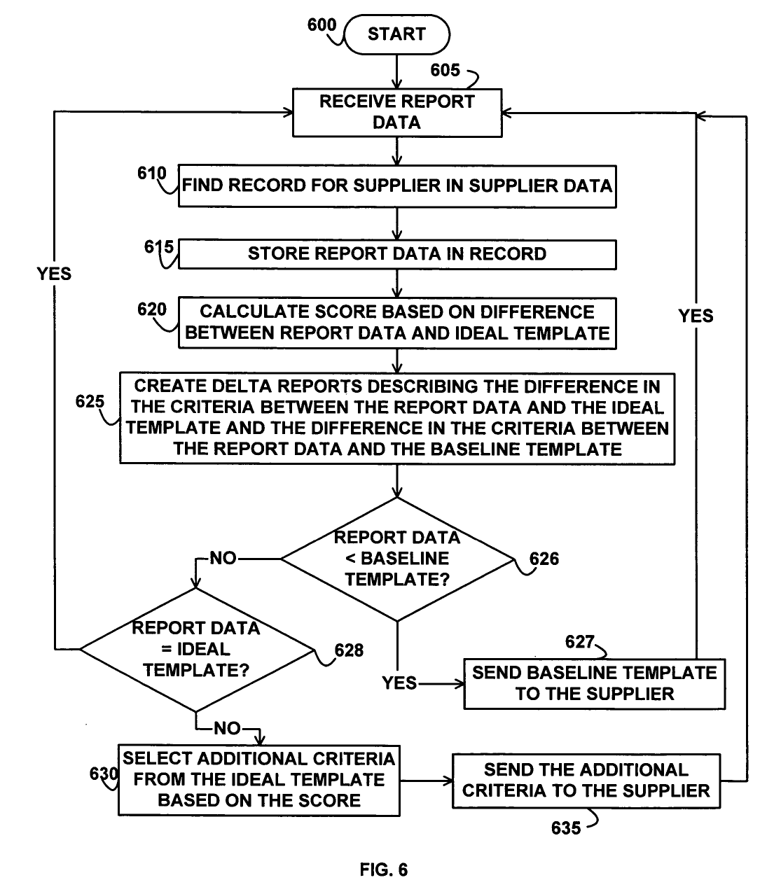

The controller 150 sends the baseline template 146 to the supplier via the client 132, receives the supplier report 144 from the supplier 210 via the client 132, and based on a score calculated from the supplier report 144 and the ideal template 148, selects and sends additional criteria from the ideal template 148 to the supplier via the client 132. In an embodiment, the controller 150 includes instructions capable of executing on the processor 101 or statements capable of being interpreted by instructions executing on the processor 101 to perform the functions as further described below with reference to FIGS. 5 and 6. In another embodiment, the controller 150 may be implemented in microcode. In yet another embodiment, the controller 150 may be implemented in hardware via logic gates and/or other appropriate hardware techniques, in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiments, many other such devices may exist, which may be of differing types.

The network interface 114 provides one or more communications paths from the computer system 100 to other digital devices and computer systems; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact, the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments, some or all of the I/O devices are connected directly to one or more system I/O buses.

The computer system 100, depicted in FIG. 1, has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3×specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 may further include some or all of the hardware components previously described above for the computer system 100. Although only one client 132 is illustrated, in other embodiments any number of clients may be present. The client 132 may include some or all of the hardware elements previously described above for the computer system 100.

It should be understood that FIG. 1 is intended to depict the representative major components of the computer system 100, the network 130, and the clients 132 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127), CD-RW, or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client company, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommended processes responsive to the analysis, generating software to implement portions of the recommended processes, and integrating the software into existing processes and infrastructure.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

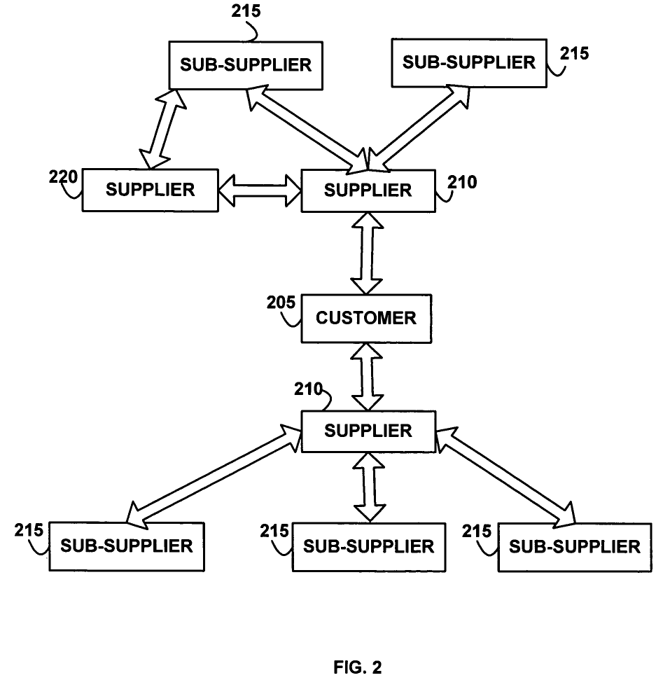

FIG. 2 depicts a block diagram of an example configuration of a customer 205, suppliers 210, and sub-suppliers 215, according to an embodiment of the invention. Some or all of the suppliers 210 may have multiple locations, such as the supplier location 220. The multiple locations of the suppliers may communicate to each other regarding their experiences in dealing with the sub-suppliers 215. The suppliers 210 supply parts, components, goods, or services to the customer 205. The sub-suppliers 215 supply parts, components, materials, goods, or services to the suppliers 210, which the suppliers 210 assemble or use to create the parts, components, materials, goods, or services that the suppliers 210 supply to the customer 205. Thus, the sub-suppliers 215 have a supplier relationship to the suppliers 210, who are the customers of the sub-suppliers 215. The sub-suppliers 215 may, in turn, have their own sub-suppliers (unillustrated) and the chain of sub-suppliers and supplier-customer relationships may continue indefinitely. The customer 205 uses the computer system 100. The suppliers 210 use the clients 132.

FIG. 3A depicts a block diagram of an example data structure for the supplier report 144, according to an embodiment of the invention. The supplier report 144 includes a supplier identifier 305, an other location report 307, a sub-supplier report 310, an incoming inspection report 315, a component placement report 320, a test report 325, a logic report 330, and a score 335.

The supplier identifier 305 identifies the supplier 210 that is associated with the record. The other location report 307 includes data that the supplier has received from other locations 220 of the supplier 210 regarding the experiences of the other locations 220 in dealing with the sub-suppliers 215. The sub-supplier report 310 includes data that the sub-supplier 215 has sent to the supplier 210 and the audits or reviews that the supplier 210 has conducted of the sub-suppliers 215. The incoming inspection report 315 includes data and/or instructions describing the actions the supplier 210 has taken in inspecting the incoming goods or services from the sub-supplier 215.

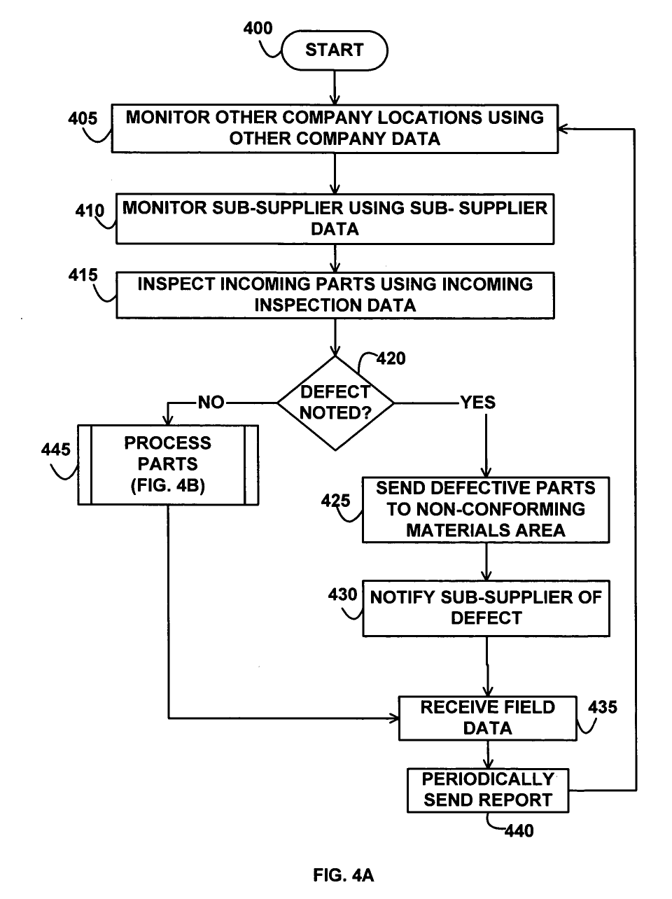

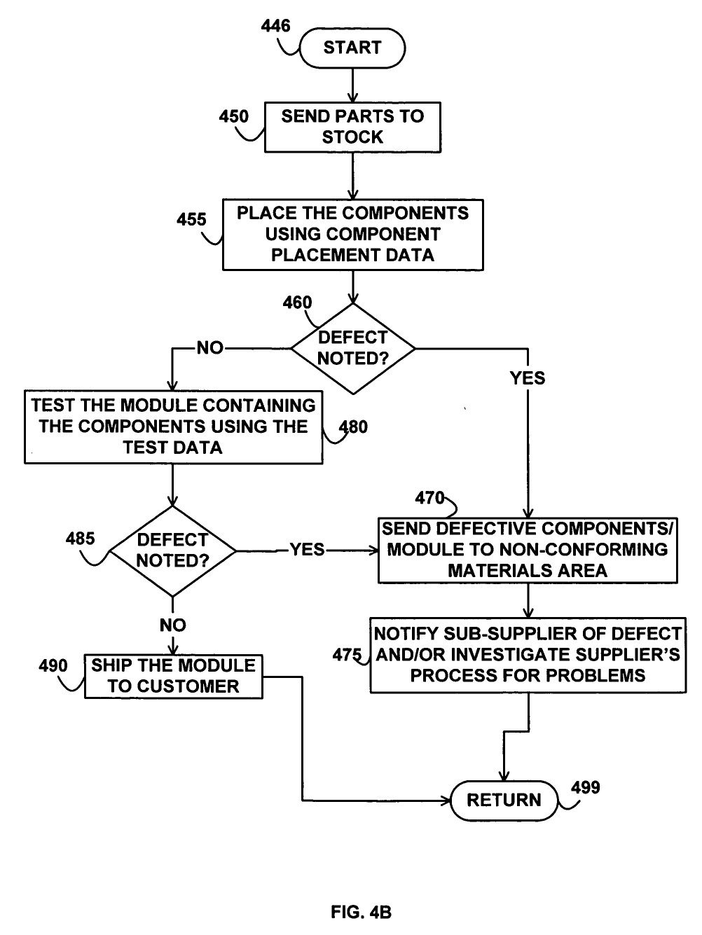

The component placement report 320 includes data describing the actions that the supplier 210 has taken in placing, assembling, or using components received from the sub-supplier 215. The test report 325 includes data describing the actions that the supplier 210 has taken in testing the placed or assembled components. The logic report 330 reports the supplier-management process or logic that the supplier 210 used in developing, manufacturing, assembling, or creating the goods or services that the supplier 210 delivers to the customer 205. An example of the logic report 330 is further described below with reference to FIGS. 4A and 4B.

The score 335 is calculated by the controller 150 and indicates the difference between the data in supplier report 144 and the criteria in the ideal template 148.

FIG. 3B depicts a block diagram of an example data structure for the baseline template 146, according to an embodiment of the invention. The baseline template 146 includes an other location baseline 337, a sub-supplier baseline 340, an incoming inspection baseline 345, a component placement baseline 350, a test baseline 355, and a logic baseline 360.

The other location baseline 337 includes minimum requirements for data that the supplier 210 must receive from other locations 220 of the supplier 210 regarding the experiences of the other locations 220 in dealing with the sub-suppliers 215.

The sub-supplier baseline 340 includes minimum data that the sub-supplier 215 must send to the supplier 210 and the minimum audits or reviews that the supplier 210 must conduct of the sub-suppliers 215.

The incoming inspection baseline 345 includes minimum data and/or instructions describing the minimum actions that the supplier 210 must take to inspect the incoming goods, parts, components, materials, or services from the sub-suppliers 215. For example, the incoming inspection baseline 345 may direct the supplier 210 to inspect incoming parts for proper dimensions, electrical compliance, handling damage, component marking, correct quantity, proper shelf life, and proper part numbers, but in other embodiments, any appropriate inspection criteria may be used.

The component placement baseline 350 includes data and/or instructions that describe the minimum actions that the supplier 210 must take to place, assemble, or use components received from the sub-supplier 215. For example, in an embodiment, the component placement baseline 350 may include instructions to verify that the correct carrier (reel, tube, tray, etc.) is in the correct location on a placement machine. The component placement baseline 350 may also include correct component orientation and placement data and data for inspection of solder joint quality.

The test baseline 355 includes data and/or instructions describing the minimum actions that the supplier 210 must take to test the placed or assembled components. For example in an embodiment, the test baseline 355 may include instructions to conduct an in-circuit test and a functional verification test.

The logic baseline 360 includes data and/or instructions that describe the minimum supplier-management process or logic that the supplier 210 must use in developing, manufacturing, assembling, or creating the goods or services that the supplier 210 delivers to the customer 205. An example of the logic baseline 360 is further described below with reference to FIGS. 4A and 4B.

FIG. 3C depicts a block diagram of an example data structure for the ideal template 148, according to an embodiment of the invention. The ideal template 148 includes an other location ideal 367, a sub-supplier ideal 370, an incoming inspection ideal 375, a component placement ideal 380, a test ideal 385, a logic ideal 390. The ideal template 148 may include all of the criteria found in the baseline template 146 plus additional criteria, or the ideal template 148 may include different criteria than the baseline template 146 in whole or in part. Thus, the criteria in the ideal template 148 is, in whole or in part, more stringent than the criteria in the baseline template 146.

The other location ideal 367 includes ideal requirements for data that the supplier must receive from other locations 220 of the supplier 210 regarding the experiences of the other locations 220 in dealing with the sub-suppliers 215.

The sub-supplier ideal 370 includes data that the sub-supplier 215 must send to the supplier 210 and the ideal audits or reviews that the supplier 210 has conducted of the sub-suppliers 215. For example, in an embodiment, the sub-supplier ideal 370 instructs the supplier 210 to ensure sub-supplier qualifications, perform quarterly business reviews of the sub-suppliers 215 and monthly quality feedback, and to audit component yield performance.

The incoming inspection ideal 375 includes data and/or instructions describing the ideal actions the supplier 210 must take to inspect the incoming goods, components, materials, or services from the sub-supplier 215. The component placement ideal 380 include data and/or instructions that describe the ideal actions that the supplier 210 must take to place, assemble, or use components received from the sub-supplier 215. The test ideal 385 includes data and/or instructions describing the ideal actions that the supplier 210 must take to test the placed or assembled components.

The logic ideal 390 includes data and/or instructions that describe the ideal supplier-management process or logic that the supplier 210 must use in developing, manufacturing, assembling, or creating the goods or services that the supplier 210 delivers to the customer. An example of the logic ideal 390 is further described below with reference to FIGS. 4A and 4B.

FIGS. 4A and 4B depict flowcharts of example logic for a supplier 210, according to an embodiment of the invention. The example logic of FIGS. 4A and 4B may represent the logic report 330, the logic baseline 360, or the logic ideal 390.

Referring to FIG. 4A, control begins at block 400. Control then continues to block 405 where the supplier 210 monitors other company locations, such as the supplier 220 using criteria received from the customer 205, for example, the other location baseline 337 or the other location ideal 367. Based on the monitoring, the supplier 210 creates the other location report 307.

Control then continues to block 410 where the supplier 210 monitors the sub-supplier 215 using the sub-supplier data, such as the sub-supplier baseline 340, the sub-supplier ideal 370, or other criteria received from the customer 205. Based on the monitoring, the supplier 210 creates the sub-supplier report 310.

Control then continues to block 415 where the supplier 210 inspects incoming parts using incoming inspection data, such as specified in the incoming inspection baseline 345 or the incoming inspection ideal 375. Control then continues to block 420 where the supplier 210 determines whether a defect is noted in the incoming parts. Based on the inspection and the determination of a defect, the supplier 210 creates the incoming inspection report 315.

If the determination at block 420 is true, then a defect is noted in the incoming parts, so control continues to block 425 where the supplier 210 sends the defective parts to a non-conforming materials area. Control then continues to block 430 where the supplier 210 notifies the sub-supplier 215 of the defect.

Control then continues to block 435 where the supplier 210 receives field data from the customer 205 via the computer system 100, such as reports from the end users of the parts, components, or modules that the supplier 210 supplies to the customer 205. Control then continues to block 440 where the supplier 210 periodically sends report data (e.g., the fields 307, 310, 315, 320, 325, and 330 in the supplier report 144) to the customer 205 via the computer system 100 and the network 130. Control then returns to block 405, as previously described above.

If the determination at block 420 is false, then a defect is not noted in the incoming parts, so control continues to block 445 where the supplier 210 processes the parts, as further described below with reference to FIG. 4B. Control then continues to block 435, as previously described above.

FIG. 4B depicts a flowchart of example logic for processing parts at the supplier 210, according to an embodiment of the invention. Control begins at block 446. Control then continues to block 450 where the supplier 210 sends the inspected parts to a stock area. Control then continues to block 455 where the supplier 210 places or assembles the received parts using the component placement criteria, such as the component placement baseline 350, the component placement ideal 380, or other criteria received from the customer 205. The supplier 210 then creates the component placement report 320.

Control then continues to block 460 where the supplier 210 determines whether a defect was noted during the placement process of block 455. If the determination at block 460 is true, then a defect was noted during the placement process, so control continues to block 470 where the supplier 210 sends the defective components to a non-conforming materials area. Control then continues to block 475 where the supplier 210 notifies the sub-supplier 215 of the defect and/or investigates the supplier's process for problems, depending on the type of defect noted. Control then continues to block 499, where the logic of FIG. 4B returns to FIG. 4A.

If the determination at block 460 is false, then a defect was not noted during the placement process, so control continues from block 460 to block 480 where the supplier 210 tests the assembled module using the test criteria, such as the test baseline 355, the test ideal 385, or other criteria received from the customer 205. The supplier 210 then creates the test report 325.

Control then continues to block 485 where the supplier 210 determines whether a defect was noted during the testing of block 480. If the determination at block 485 is true, then a defect was noted, so control continues to block 470, as previously described above.

If the determination at block 485 is false, then a defect was not noted, so control continues to block 490 where the supplier 210 ships the assembled module to the customer 205. Control then continues to block 499 where the logic of FIG. 4B returns to FIG. 4A.

FIG. 5 depicts a flowchart for sending the baseline template 146 to a supplier 210 via the client 132, according to an embodiment of the invention. Control begins at block 500. Control then continues to block 505 where the controller 150 creates the supplier identifier 305 in the supplier report 144. Control then continues to block 510 where the controller 150 sends the baseline template 146 to the supplier 210 via the client 132. Control then continues to block 599 where the logic of FIG. 5 returns.

FIG. 6 depicts a flowchart of example processing for processing a report received from the supplier 210, according to an embodiment of the invention. Control begins at block 600. Control then continues to block 605 where the controller 150 receives report data (e.g., the fields 307, 310, 315, 320, 325, and 330 in the supplier report 144) from the supplier 210 via the client 132.

Control then continues to block 610 where the controller 150 finds the supplier identifier 305 in the supplier report 144 that is associated with the supplier 210. Control then continues to block 615 where the controller 150 stores the received report data in the supplier report 144. Control then continues to block 620 where the controller 150 calculates the score 335 based on the difference between the received report data in the supplier report 144 and the ideal template 148, which represents the difference between the supplier-management process that the supplier 210 has implemented and the ideal supplier-management process. Control then continues to block 625 where the controller 150 creates delta reports. In an embodiment, a delta report describes the difference in the criteria between the report data in the supplier report 144 and the ideal template 148. In another embodiment, the delta report describes the difference in the criteria between the report data in the supplier report 144 and the baseline template 146.

Control then continues to block 626 where the controller 150 determines whether the report data in the supplier report 144 is less than the baseline template 146. If the determination at block 626 is true, then control continues to block 627 where the controller 150 sends the baseline template 146 to the supplier 210 at the client 132. Control then returns to block 605, as previously described above.

If the determination at block 626 is false, then control continues to block 628 where the controller 150 determines whether the received report data equals the ideal template 148.

If the determination at block 628 is true, then the supplier 210 has implemented the ideal supplier-management process, so control returns to block 605, as previously described above.

If the determination at block 628 is false, then the supplier 210 has not implemented the ideal supplier-management process, so control continues to block 630 where the controller 150 selects additional criteria from the ideal template 148 based on the score 335. Control then continues to block 635 where the controller 150 sends the additional criteria to the supplier 210 via the client 132. Control then returns to block 605, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention. But, other embodiments may be utilized, such as logical, mechanical, electrical, and other changes that may be made without departing from the scope of the present invention. Different instances of the word “embodiment,” as used within this specification, do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
repeatedly sending different criteria to a supplier, wherein the different criteria moves the supplier from a baseline supplier-management process towards an ideal supplier-management process.

2. The method of claim 1, further comprising:
sending the baseline supplier-management process to the supplier.

3. The method of claim 1, further comprising:
selecting the different criteria from the ideal supplier-management process.

4. The method of claim 1, further comprising:
selecting the different criteria based on a difference between a report from the supplier and the ideal supplier-management process.

5. An apparatus comprising:
means for receiving a report from the supplier;
means for calculating a score based on a difference between the report and an ideal supplier-management process;
means for selecting criteria based on the score; and
means for sending the criteria to the supplier, wherein the criteria moves the supplier from a baseline supplier-management process towards the ideal supplier-management process.

6. The apparatus of claim 5, further comprising:
means for sending a baseline template to the supplier, wherein the baseline supplier-management process is based on the baseline template.

7. The apparatus of claim 6, wherein the baseline template comprises a logic baseline.

8. The apparatus of claim 6, wherein the baseline template directs the supplier to inspect components from a sub-supplier.

9. A signal-bearing medium encoded with instructions, wherein the instructions when executed comprise:
sending a baseline template to the supplier;
receiving a report from the supplier;
calculating a score based on a difference between the report and an ideal supplier-management process;
selecting criteria based on the score; and
sending the criteria to the supplier, wherein the criteria moves the supplier from a baseline supplier-management process towards the ideal supplier-management process, wherein the baseline supplier-management process is based on the baseline template.

10. The signal-bearing medium of claim 9, wherein the baseline template directs the supplier to test components from a sub-supplier.

11. The signal-bearing medium of claim 9, wherein the baseline template directs the supplier to assemble components from a sub-supplier.

12. The signal-bearing medium of claim 9, wherein the baseline template directs the supplier to audit a sub-supplier.

13. A computer system comprising:
a processor; and
memory encoded with instructions, wherein the instructions when executed on the processor comprise:
sending a baseline template to the supplier,
receiving a report from the supplier,
calculating a score based on a difference between the report and an ideal supplier-management process,
selecting criteria from the ideal supplier-management process based on the score, and
sending the criteria to the supplier, wherein the criteria moves the supplier from a baseline supplier-management process towards the ideal supplier-management process, wherein the baseline supplier-management process is based on the baseline template.

14. The computer system of claim 13, wherein the instructions further comprise:
creating a delta report, wherein the delta report describes a difference between the report and the ideal supplier-management process.

15. The computer system of claim 13, wherein the instructions further comprise:
creating a delta report, wherein the delta report describes a difference between the report and the baseline supplier-management process.

16. The computer system of claim 13, wherein the sending a baseline template to the supplier further comprises:
sending the baseline template to the supplier if the report is less than the baseline supplier-management process.

17. A method for configuring a computer, comprising:
configuring the computer to repeatedly send different criteria to a supplier, wherein the different criteria moves the supplier from a baseline supplier-management process towards an ideal supplier-management process.

18. The method of claim 17, further comprising:
configuring the computer to send the baseline supplier-management process to the supplier.

19. The method of claim 17, further comprising:
configuring the computer to select the different criteria from the ideal supplier-management process.

20. The method of claim 17, further comprising:
configuring the computer to select the different criteria based on a difference between a report from the supplier and the ideal supplier-management process.

21. A business process consulting method, comprising analyzing a client business process to generate a baseline template, the baseline template specifying supplier management criteria for a desired supplier management process.

22. The business process consulting method of claim 21, further comprising:
communicating the baseline template to a supplier of the client business;
receiving supplier management process reports from the supplier of the client business;
generating a recommendation based on a difference between the baseline template and the supplier management process reports; and
communicating the recommendation to the supplier of the client business, wherein the recommendation moves the supplier toward the desired supplier management process.
